(19) United States
(12) Patent Application Publication
(10) Pub. No.: US 2025/0284515 A1
(43) Pub. Date: Sep. 11, 2025

(54) OPTIMIZING VIRTUALIZED NODE SELECTION

(71) Applicant: Capital One Services, LLC, McLean, VA (US)

(72) Inventors: Brent SEGNER, Marysville, OH (US); Andrew STERN, Arlington, VA (US); Mark O. SCHUTT, Chesterfield, VA (US); John ELY, Henrico, VA (US)

(21) Appl. No.: 18/600,565

(22) Filed: Mar. 8, 2024

(51) Int. Cl. G06F 9/455

(52) U.S. Cl. CPC G06F 9/45558; G06F 2009/45595

(57) ABSTRACT

In some implementations, a device may obtain telemetry data associated with the cloud computing environment, wherein the telemetry data indicates one or more processing parameters of an application deployed in the cloud computing environment via a current virtualized node. The device may determine, for the application, a processing capacity utilization score of the application. The device may determine, based on the processing capacity utilization score and the one or more processing parameters, one or more recommended virtualized nodes from one or more virtualized nodes associated with the cloud computing environment. The device may perform an action associated with a selection of an operating virtualized node for the application from the current virtualized node and the one or more recommended virtualized nodes.

### BACKGROUND

Cloud computing refers to network-based on-demand availability of computer system resources, such as data storage and computing power. Cloud computing providers typically offer service according to different service models, such as infrastructure as a service (IaaS), platform as a service (PaaS), and/or software as a service (SaaS), among other examples.

In a cloud computing environment, a physical processor may support the operation of one or more virtualized instances in the cloud computing environment. For example, the physical processor may allocate hardware resources (such as cores, memory, and/or storage) to one or more virtualized instances, facilitated by virtualization software, such as hypervisors or container runtimes, among other examples. The virtualization software layer ensures resource isolation and management, allowing multiple virtualized instances to coexist on the same physical hardware (e.g., the same physical processor) without interference. The virtualization software layer may manage the execution of the virtualized instances, scheduling time slices, coordinating memory access, and/or handling input/output operations, among other examples. Features embedded within the physical processor, such as support for hardware virtualization and/or multiple cores, may optimize the performance of the virtualized instances by facilitating efficient resource utilization and enhancing performance isolation.

### SUMMARY

Some implementations described herein relate to a system for optimizing virtualized node selection in a cloud computing environment. The system may include one or more memories and one or more processors communicatively coupled to the one or more memories. The one or more processors may be configured to determine a baseline processing performance score using an origin virtualized node deployed in the cloud computing environment, wherein the baseline processing performance score is based on a processing performance of a physical processing system supporting the origin virtualized node. The one or more processors may be configured to determine relative ratios for respective virtualized nodes of one or more virtualized nodes deployed in the cloud computing environment, wherein the relative ratios indicate relative processing performances that are relative to the processing performance. The one or more processors may be configured to determine processing performance scores for the respective virtualized nodes based on the relative ratios and the baseline processing performance score. The one or more processors may be configured to determine, for an application deployed in the cloud computing environment via a virtualized node of the one or more virtualized nodes, a processing capacity utilization score based on a processing performance score of the virtualized node and a utilization score of the application that is based on telemetry data associated with the application and one or more processing characteristics of the virtualized node. The one or more processors may be configured to determine, based on the processing capacity utilization score and one or more processing parameters of the application, one or more recommended virtualized nodes from the one or more virtualized nodes. The one or more processors may be configured to perform, based on efficiency scores for respective virtualized nodes of the one or more recommended virtualized nodes and the virtualized node, an action associated with a selection of an operating virtualized node for the application from the virtualized node and the one or more recommended virtualized nodes.

Some implementations described herein relate to a method for optimizing virtualized node selection in a cloud computing environment comprising: The method may include obtaining, by a device, telemetry data associated with the cloud computing environment, wherein the telemetry data indicates one or more processing parameters of an application deployed in the cloud computing environment via a current virtualized node. The method may include determining, by the device and for the application, a processing capacity utilization score based on a processing performance score of the current virtualized node and a utilization score of the application that is based on the one or more processing parameters and one or more processing characteristics of the current virtualized node, wherein the processing performance score is based on a baseline processing performance score of an origin virtualized node and a relative ratio indicating a first processing performance of the current virtualized node relative to a second processing performance associated with the origin virtualized node. The method may include determining, by the device and based on the processing capacity utilization score and the one or more processing parameters, one or more recommended virtualized nodes from one or more virtualized nodes associated with the cloud computing environment, wherein the one or more recommended virtualized nodes satisfy one or more processing performance criteria for the application indicated by the processing capacity utilization score and the one or more processing parameters. The method may include performing, by the device and based on efficiency scores for respective virtualized nodes of the one or more recommended virtualized nodes and the current virtualized node, an action associated with a selection of an operating virtualized node for the application from the current virtualized node and the one or more recommended virtualized nodes.

Some implementations described herein relate to a non-transitory computer-readable medium that stores a set of instructions. The set of instructions, when executed by one or more processors of a device, may cause the device to obtain telemetry data associated with a cloud computing environment, wherein the telemetry data indicates one or more processing parameters of an application deployed in the cloud computing environment via a current virtualized node. The set of instructions, when executed by one or more processors of the device, may cause the device to determine, for the application, a processing capacity utilization score based on a processing performance score of the current virtualized node and a utilization score of the application that is based on the one or more processing parameters and one or more processing characteristics of the current virtualized node, wherein the processing performance score is based on a baseline processing performance score of an origin virtualized node and a relative ratio indicating a first processing performance of the current virtualized node relative to a second processing performance associated with the origin virtualized node. The set of instructions, when executed by one or more processors of the device, may cause the device to determine, based on the processing capacity utilization score and the one or more processing parameters, one or more recommended virtualized nodes from one or more virtualized nodes associated with the cloud computing environment, wherein the one or more recommended virtualized nodes meet one or more processing performance criteria for the application indicated by the processing capacity utilization score and the one or more processing parameters. The set of instructions, when executed by one or more processors of the device, may cause the device to perform, based on efficiency scores for respective virtualized nodes of the one or more recommended virtualized nodes and the current virtualized node, an action associated with a selection of an operating virtualized node for the application from the current virtualized node and the one or more recommended virtualized nodes.

### BRIEF DESCRIPTION OF THE DRAWINGS

FIGS. 1A-1F are diagrams of an example associated with optimizing virtualized node selection, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with optimizing virtualized node selection, in accordance with some embodiments of the present disclosure.

FIG. 4 is a flowchart of an example process associated with optimizing virtualized node selection, in accordance with some embodiments of the present disclosure.

### DETAILED DESCRIPTION

The following detailed description of example implementations refers to the accompanying drawings. The same reference numbers in different drawings may identify the same or similar elements.

Some tasks are particularly suitable for execution in a cloud environment. A “task” may refer to a computational process for a computer (e.g., execution of a model, sorting and classification of a data set, or migration of a database to another data structure, among other examples). A task may include multiple computational processes that are all logically grouped in a same job. For example, a user may write a configuration file (or another data structure including task instructions) that instructs a cloud environment to perform a job that includes a series of computational processes.

Tasks associated with large data sets are often more efficient to execute in virtual environments rather than on local machines. In another example, tasks associated with large computational power are often more efficient to execute on distributed computing networks rather than on local machines. There are multiple providers of cloud computing resources. For example, AMAZON® provides ELASTIC COMPUTE CLOUD (EC2®) and ELASTIC KUBERNETES SERVICE (EKS), among other examples. Similarly, GOOGLE® provides the GOOGLE COMPUTE ENGINE (GCE) and the GOOGLE CLOUD DATAPROC. MICROSOFT® offers AZURE® Virtual Machines and AZURE DATA LAKE ANALYTICS.

In a cloud computing environment, a physical processor (or processing system that includes one or more physical processors) may support the operation of one or more virtualized nodes in the cloud computing environment (e.g., may provide processing resources and/or computing resources for cloud computing resources). For example, the physical processor may allocate hardware resources (such as cores, memory, and/or storage) to one or more virtualized nodes, facilitated by virtualization software, such as hypervisors or container runtimes, among other examples. As used herein, “virtualized node” may refer to a cloud computing node, a virtualized node in a cloud computing environment, an instance, a virtualized instance, a virtual computing system, a container, a virtual machine, a serverless function (e.g., an anonymous function or a Lambda function), and/or another component configured to execute in a cloud computing environment with the support of a physical processor or physical processing system. “Virtualized node” may be used interchangeably with virtualized instance, node, instance, and/or similar terms herein. As explained in more detail elsewhere herein, a cloud computing system may enable multiple virtualized nodes to execute on a single physical machine or system (e.g., a processor or processing system), sharing resources of the single physical machine or system (such as processing resources, computing resources, memory resources, storage resources, and/or network bandwidth resources). A processing performance or capability of a virtualized node may be based on the underlying capabilities, configuration, and/or characteristics of the physical processor (or processing system) supporting the virtualized node.

An application (also referred to herein as a workload) may be deployed in the cloud computing environment via one or more virtualized nodes. If the one or more virtualized nodes have insufficient resources to support the application (e.g., insufficient processing resources, insufficient computing resources, insufficient memory resources, insufficient bandwidth, and/or other insufficient resources), then a performance of the application may be degraded. Therefore, deployment of applications are typically overprovisioned. “Overprovisioned” or “over provisioning” may refer to deploying an application via a virtualized node that has more cloud computing resources (e.g., processing resources, computing resources, memory resources, bandwidth, and/or other resources) than are needed to support the application. This reduces the risk of the virtualized node having insufficient resources to support the application, thereby reducing the likelihood of degraded performance for the application.

However, over provisioning virtualized nodes in a cloud computing environment may reduce the performance of the cloud computing environment. For example, over provisioning may result in virtualized nodes being deployed that consume significantly more cloud computing resources (e.g., processing resources, computing resources, memory resources, bandwidth, and/or other resources) than are needed to support one or more applications (or workloads) that are deployed via the cloud computing environment. The consumption of the additional cloud computing resources may degrade the performance of the cloud computing system, such as by reducing processing speed or capability due to the increased cloud computing resources.

However, it may be difficult to accurately predict or determine whether a virtualized node is over provisioned for a given application or workload. For example, as described elsewhere herein, different virtualized nodes may be supported by different types of physical processors or physical processing systems. Comparing the processing performance of virtualized nodes supported by different physical processors is difficult because of variations in architecture, core count, clock speed, cache hierarchy, instruction set extensions, and/or virtualization features, among other examples, between the different physical processors. These differences influence overall processing performance of a virtualized node and make direct comparisons difficult among virtualized nodes supported by different types of physical processors or processing systems. Therefore, the relative performance across different hardware platforms may be inaccurate and/or may not yield directly comparable results. As a result, if a deployment of an application is switched to a different virtualized node that is indicated as having cloud computing resources that are more aligned with the application (e.g., that are closer to an actual processing utilization of the application) using an inaccurate relative performance comparison, this may result in the application being deployed via a virtualized node having insufficient cloud computing resources to support the application, thereby degrading the performance of the application. Alternatively, if a deployment of an application uses a virtualized node having overprovisioned cloud computing resources for the application, this may degrade the performance of the cloud computing system, as described elsewhere herein.

Some implementations described herein enable optimized virtualized node selection. For example, an optimization device may use a processing performance score (e.g., a standardized score to compare processing performance and/or capability across virtualized nodes supported by different types of physical processors or physical processing system) and telemetry data from the cloud computing environment to select an optimized virtualized node for a given application or workload. For example, the optimization device may obtain telemetry data from the cloud system to determine performance requirements of an application based on the telemetry data, the virtualized instance that the application is currently deployed on, and a processing performance score for the virtualized instance on which the application is currently deployed. The optimization device may identify one or more recommended virtualized nodes that may be more efficient for the deployment of the application using a processing capacity utilization score of the application. In some implementations, the optimization device may determine efficiency scores for respective virtualized nodes of the one or more recommended virtualized nodes using one or more efficiency metrics (e.g., for one or more resources associated with the cloud computing environment). The optimization device may perform an action associated with a selection of a virtualized node via which the application is to be deployed, such as displaying the one or more recommended virtualized nodes (e.g., to enable a user to view and select one of the recommended virtualized nodes) and/or causing the application to be deployed via one of the recommended virtualized nodes.

In some implementations, the optimization device may determine processing performance scores for respective virtualized nodes associated with a cloud computing environment. For example, the optimization device may determine a baseline processing performance score using an origin virtualized node deployed in the cloud computing environment. The baseline processing performance score is based on a processing performance of a physical processing system supporting the origin virtualized node. The optimization device may determine relative ratios for respective virtualized nodes of one or more virtualized nodes deployed in the cloud computing environment. The relative ratios indicate relative processing performances that are relative to the processing performance of the physical processing system supporting the origin virtualized node. The optimization device may determine processing performance scores for the respective virtualized nodes based on the relative ratios and the baseline processing performance score.

As a result, the application may be deployed via a virtualized instance that is optimized for the actual processing capacity utilization of the application. For example, by using processing performance scores that are determined as described herein, the optimization device may accurately and/or reliably compare the processing performance, processing capacity, and/or processing capabilities of virtualized nodes that are supported by different types of physical processors and/or processing systems. The accurate and/or reliable comparison of the processing performance, processing capacity, and/or processing capabilities enables the optimization device to improve the selection of a virtualized node via which a given application is to be deployed. For example, by using the processing capacity utilization score (and one or more processing parameters of the application, such as memory utilization and/or disk utilization), the optimization device may improve the selection of the virtualized node via which a given application is to be deployed using processing performance scores of respective virtualized instances and processing characteristics of the respective virtualized nodes. By enabling the selection of an optimized virtualized node for the application, a resource utilization efficiency of the cloud computing environment may be improved. The improvement of the resource utilization efficiency may improve the overall performance of the cloud computing environment, such as increasing processing speed and/or capacity of cloud computing resources associated with the cloud computing environment.

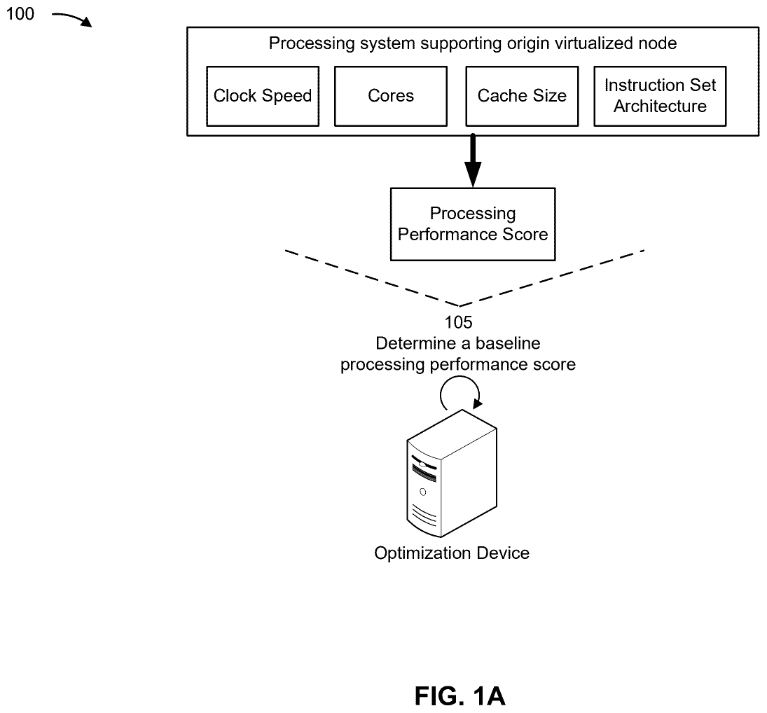

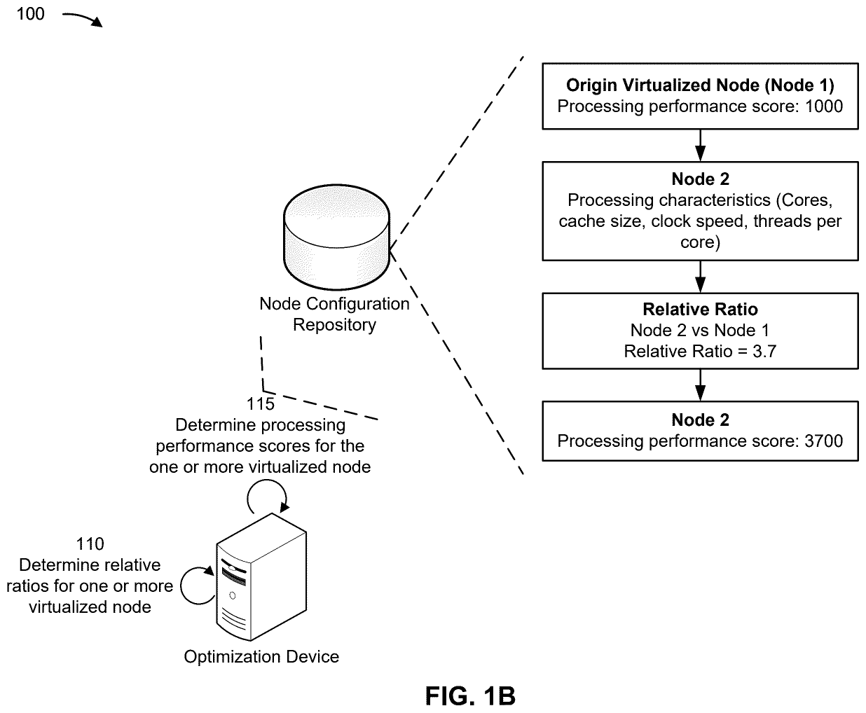

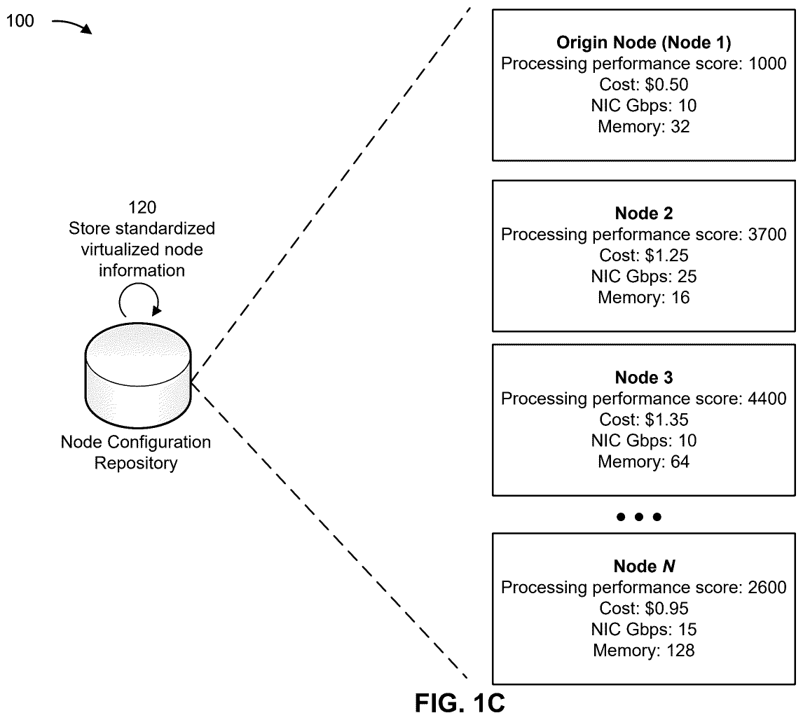

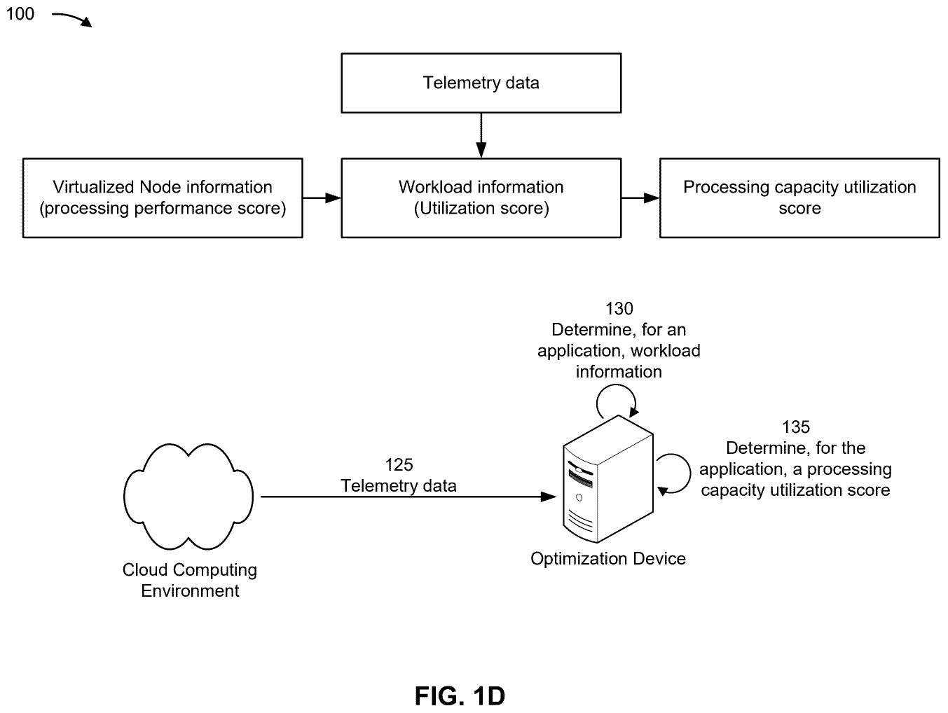

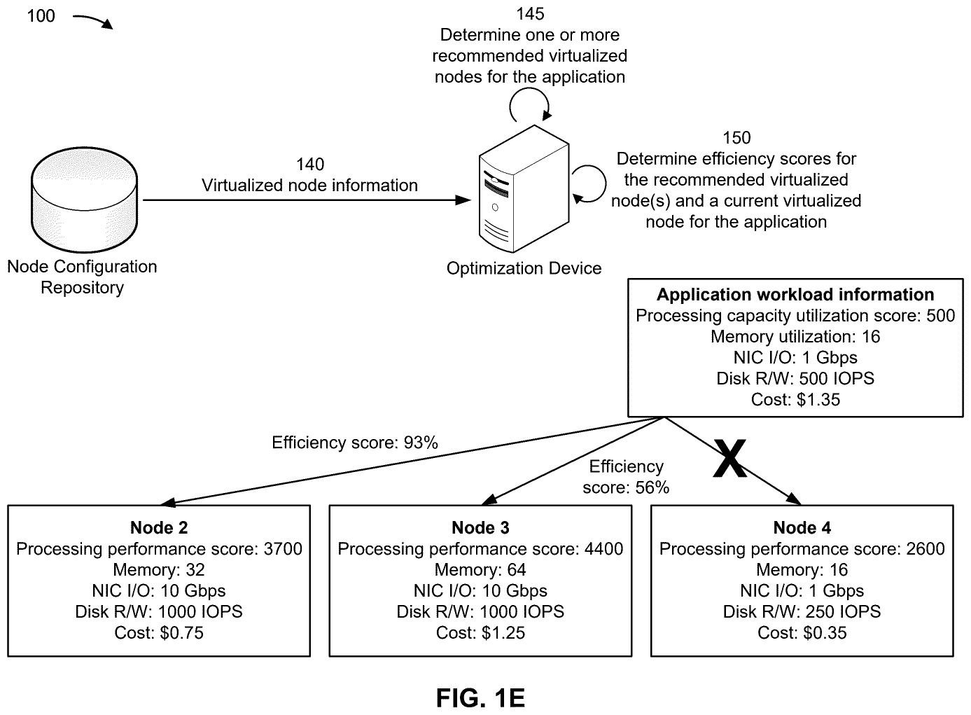

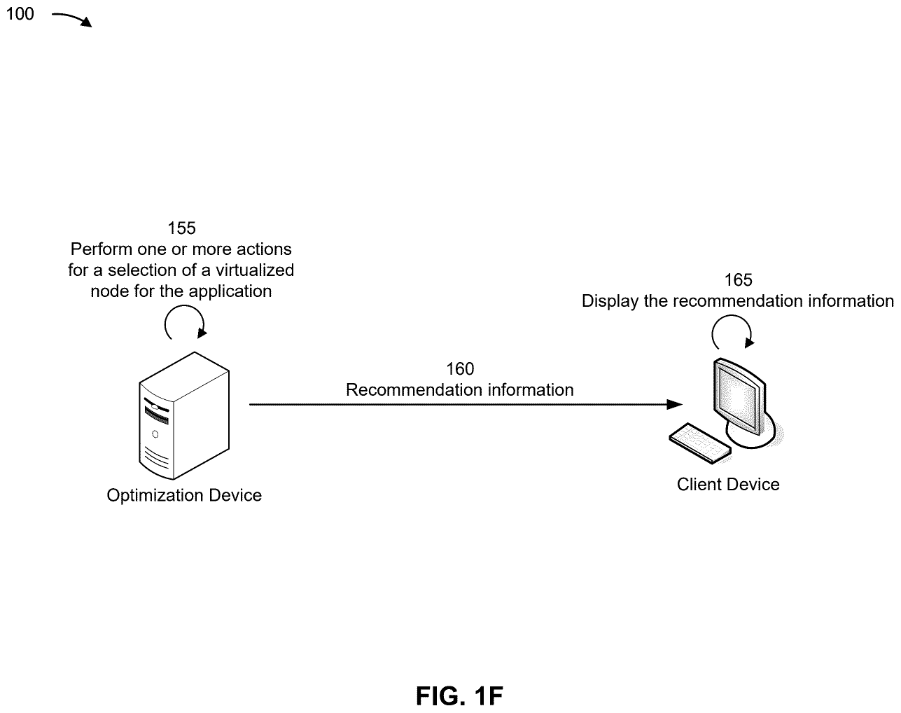

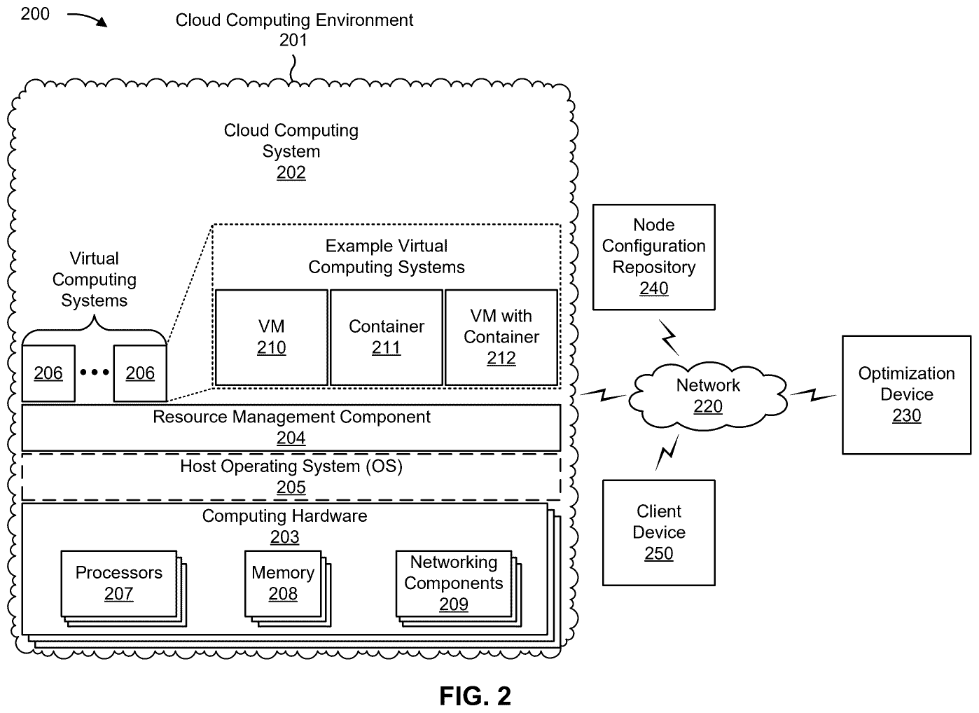

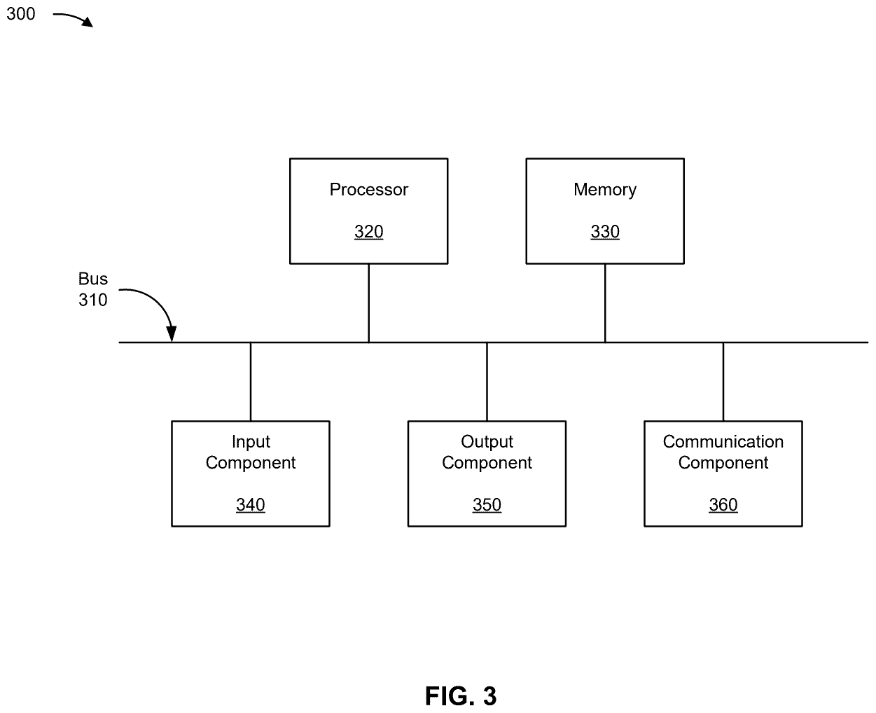

FIGS. 1A-1F are diagrams of an example 100 associated with optimizing virtualized node selection. As shown in FIGS. 1A-1F, example 100 includes an optimization device, a node configuration repository, a cloud computing environment, and a client device. These devices are described in more detail in connection with FIGS. 2 and 3.

As shown in FIG. 1A, and by reference number 105, the optimization device may determine a baseline processing performance score. The processing performance score may be a score indicative of a processing performance, processing capability, and/or processing capacity, among other examples, of a virtualized node in the cloud computing environment. For example, the optimization device may determine the baseline processing performance score using an origin virtualized node. As used herein, “origin” virtualized node may refer to a virtualized node that is used to determine or calculate the baseline processing performance score. For example, the origin virtualized node can be any virtualized node associated with the cloud computing environment (e.g., deployed in the cloud computing environment). As used herein, “processing performance” may refer to a processing speed, processing capacity, and/or other processing capability.

The baseline processing performance score may be based on a processing performance of a physical processing system supporting the origin virtualized node. A physical processing system may include one or more physical processors or devices. For example, the processing performance of a virtualized node may be based on the capabilities or configuration (e.g., processing characteristics) of the physical processing system supporting the virtualized node. For example, the processing characteristics of a physical processing system may include an architecture, a quantity of cores (and/or supported threads), a clock speed, a cache size and/or hierarchy, a virtualization extension, and/or a resource allocation and management configuration (e.g., a hypervisor configuration), among other examples. For example, the architecture of the physical processing system may include an instruction set architecture. The architecture of the physical processing system may impact the processing performance or capability of the virtualized node. For example, if the physical processing system supports an advanced instruction set architecture, such as single instruction, multiple data (SIMD), virtualized instances executing on the physical processing system may experience accelerated or improved processing for tasks that utilize these instructions. Therefore, the instruction set architecture of the physical processing system may impact the processing performance of a virtualized instance supported by the physical processing system.

As another example, the quantity of cores and/or threads in the physical processing system may impact the processing performance of a virtualized instance supported by the physical processing system. For example, the quantity of cores and/or threads in the physical processing system may define how many virtualized node can execute concurrently on the physical processing system without experiencing performance degradation due to resource contention. For example, each virtual node may be allocated a certain quantity of virtual central processing units (CPUs) (vCPUs), which are mapped to physical CPU cores or threads of the physical processing system. If the physical processing system has more cores and threads, then the physical processing system can support a greater quantity of virtualized nodes simultaneously. As another example, the clock speed of the physical processing system may impact the processing performance of a virtualized instance supported by the physical processing system. For example, higher clock speeds may result in faster processing, improving the performance of applications running via the virtualized node.

As another example, the cache size and/or cache hierarchy (e.g., level 1 (L1) cache, level 2 (L2) cache, and/or level 3 (L3) cache hierarchy) may impact the processing performance of a virtualized instance supported by the physical processing system. For example, larger caches and/or optimized cache hierarchies can improve the efficiency of memory access via the physical processing system, thereby reducing latency and/or improving overall processing performance for a virtualized instance supported by the physical processing system. As another example, virtualization extensions supported by the physical processing system may improve the efficiency and/or performance of virtualization via the physical processing system by offloading one or more virtualization related tasks to physical hardware, reducing processing overhead and/or improving performance for a virtualized instance supported by the physical processing system.

The optimization device may determine the baseline processing performance score using one or more characteristics or parameters of the physical processing system supporting the origin virtualized node. In some implementations, as shown in FIG. 1A as an example, the optimization device may determine the baseline processing performance score based on a clock speed, a quantity of cores, a cache size (e.g., an L1 cache size, an L2 cache size, and/or an L3 cache size), and/or an instruction set architecture, among other examples of the physical processing system supporting the origin virtualized node. The processing performance score may be a value and/or other benchmark to establish a baseline for the amount of processing capacity that a virtualized node (e.g., supported by the physical processing system) is capable of. For example, the processing performance score may be indicative of a total processing capacity of the origin virtualized node.

As shown in FIG. 1B, and by reference number 110, the optimization device may determine relative ratios for one or more virtualized nodes associated with the cloud computing environment (e.g., deployed in the cloud computing environment). For example, when (e.g., prior to or after) a virtualized node is deployed in the cloud computing environment, the optimization device may determine a relative ratio for the virtualized node. A relative ratio may indicate a relative processing performance for a given virtualized node that is relative to the processing performance of the origin virtualized node (e.g., of the physical processing system supporting the origin virtualized node).

For example, a relative ratio of R may indicate that a given virtualized node has a processing performance of R times the processing performance of the origin virtualized node (e.g., of the physical processing system supporting the origin virtualized node). The relative ratios may be based on respective processing characteristics of physical processing systems supporting the one or more virtualized nodes. For example, the processing characteristics may include clock speed, quantity of cores (and/or quantity of threads or quantity of threads per core), cache size (e.g., an L1 cache size, an L2 cache size, and/or an L3 cache size), and/or instruction set architecture, among other examples. The optimization device may determine the relative ratio for a given virtualized node based on a comparison of processing characteristics of a physical processing system supporting the given virtualized node to processing characteristics of the physical processing system supporting the origin virtualized node. The optimization device may determine relative ratios for other virtualized nodes in the cloud computing environment in a similar manner.

As shown by reference number 115, the optimization device may determine processing performance scores for one or more virtualized nodes associated with the cloud computing environment (e.g., deployed in the cloud computing environment). For example, when (e.g., prior to or after) a virtualized node is deployed in the cloud computing environment, the optimization device may determine a processing performance score for the virtualized node. The optimization device may determine processing performance scores for the respective virtualized nodes based on relative ratios and the baseline processing performance score. For example, the processing performance scores for the one or more virtualized nodes may be relative to the baseline processing performance score of the origin virtualized node. In some implementations, the processing performance scores (and/or processing characteristics) of respective virtualized nodes may be stored via the node configuration repository.

For example, as shown in FIG. 1B, the optimization device may determine that the original virtualized node (e.g., Node 1 as shown in FIG. 1B) has a processing performance score of 1000 (e.g., as described in connection with FIG. 1A and reference number 105). The optimization device may determine that another virtualized node (e.g., Node 2 as shown in FIG. 1B) has a certain processing characteristics based on a physical processing system that supported the virtualized node. Based on the certain processing characteristics, the optimization device may determine that the virtualized node (e.g., the Node 2) has a relative ratio of 3.7 (e.g., as described in connection with reference number 110). This may indicate that the virtualized node (e.g., the Node 2) has 3.7 times the processing capacity or processing performance as the origin virtualized node (e.g., the Node 1). As a result, the optimization device may determine that the virtualized node (e.g., the Node 2) has a processing performance score of 3700 (e.g., 1000 times 3.7).

In other words, the processing performance score for a given virtualized node may be the baseline processing performance score multiplied by the relative ratio for the given virtualized node. The optimization device may determine processing performance scores for other virtualized nodes in a similar manner. This enables the optimization device may quantify the processing capability and attributes of virtualized nodes in the cloud computing environment in a manner that allows for a meaningful comparison of one virtualized node against another virtualized node to determine which one is most suitable to meet performance requirements of an application at an optimized efficiency, as described elsewhere herein.

As shown in FIG. 1C, and by reference number 120, the node configuration repository may store virtualized node information. For example, the optimization device may store the virtualized node information (or may cause the virtualized node information to be stored) by the node configuration repository. The virtualized node information for a given virtualized node may include a processing performance score, one or more processing characteristics (e.g., clock speed, quantity of cores (and/or quantity of threads or quantity of threads per core), cache size (e.g., an L1 cache size, an L2 cache size, and/or an L3 cache size), and/or instruction set architecture), a memory attribute (e.g., a memory size), a disk attribute (e.g., an input/output operations per second (IOPS) attribute), a network performance attribute (e.g., a network interface card (NIC) attribute measured in gigabits per second (Gbps), such as a data transfer rate, throughput capacity, or bandwidth capacity of the NIC), a cost attribute (e.g., indicating a cost (such as per hour) that is charged by a cloud service provider of the virtualized node for deploying the virtualized node), and/or other attributes or information of the virtualized node. For example, as shown in FIG. 1C, the node configuration repository may store virtualized node information for one or more virtualized nodes associated with the cloud computing environment, such as a Node 1 (e.g., the original virtualized node) through a Node N.

As shown in FIG. 1D, and by reference number 125, the optimization device may obtain telemetry data via the cloud computing environment. The telemetry data may be information collected from one or more sources within the cloud computing environment, such as virtualized nodes, servers, network devices, storage systems (e.g., repositories), and/or applications, among other examples. For example, the telemetry data may indicate an operational status, one or more performance metrics, one or more usage patterns, and/or health information for one or more cloud computing resources. For example, the telemetry data may indicate CPU utilization, memory usage, disk input/output operations (I/O), network traffic, error rates, and/or latency, among other examples. In some implementations, the telemetry data may be associated with a given application or workload deployed in the cloud computing environment.

As shown by reference number 130, the optimization device may determine, for an application, workload information. The workload information may indicate performance needs or utilizations of the application. The optimization device may determine the workload information based on the telemetry data. For example, the workload information may indicate a processing utilization, a memory utilization, a NIC I/O utilization, and/or a disk IOPS utilization, among other examples, for the application.

In some implementations the workload information may include a quantity of resources (e.g., a resource quantity) being used by the application, such as a quantity of CPUs, a quantity of virtual NICs, a quantity of memory allocated for the application, and/or a quantity of memory utilized by the application, among other examples. Additionally, or alternatively, the workload information may include one or more resource performance settings. For example, the workload information may include a processor version and/or frequency (e.g., a CPU performance setting), and/or a NIC setting (e.g., a NIC capacity), among other examples. Additionally, or alternatively, the workload information may include a quantity of packets transmitted and/or received via one or more virtual NICs by the application (e.g., a quantity of communicated packets). Additionally, or alternatively, the workload information may include a size (e.g., in bytes) of the packets transmitted and/or received via one or more virtual NICs by the application (e.g., a size of communicated data or communicated packets). Additionally, or alternatively, the workload information may include a quantity of read and/or write requests transmitted to a disk by the application. Additionally, or alternatively, the workload information may include a size of the read and/or write requests transmitted to the disk by the application. Additionally, or alternatively, the workload information may include one or more software library architecture parameters (e.g., requirements) of the application. The composite of workload information collected through telemetry data may create a more robust understanding of the application that can be used to identify how the application appears to the cloud infrastructure and what is required to meet performance requirements of the application.

The optimization device may determine a utilization score for the application based on the workload information and one or more processing characteristics of a virtualized node via which the application is currently deployed (referred to herein as a “current” virtualized node for the application). The utilization score may indicate an amount of resources of the current virtualized node that are being utilized by the application. For example, the utilization score may be a percentage of the resources of the current virtualized node that are being utilized by the application. The utilization score may indicate a utilization of processing resources (e.g., CPU utilization and/or graphics processing unit (GPU) utilization), memory resources, network resources, disk resources, and/or another type of resource. For example, the utilization score may be an amount of a type of resource used by the application divided by the total amount of resources available to the application via the current virtualized node.

As shown by reference number 135, the optimization device may determine, for the application, a processing capacity utilization score. The processing capacity utilization score may be based on a processing performance score of the current virtualized node and a utilization score of the application. The processing capacity utilization score may indicate how much computation power was consumed out of a processor complex by a workload (e.g., by an application). The processing capacity utilization score may indicate a processing utilization of the application that is standardized and/or is comparable across virtualized nodes supported by different types of processing systems. For example, because the processing capacity utilization score is based at least in part on the processing performance score of the current virtualized node, the processing capacity utilization score may be used to reliably compare the amount of processing resources consumed by the application across different virtualized nodes. For example, while a utilization score may be indicative of utilization by the application for a given virtualized node, the processing capacity utilization score may convert the utilization score into units that are comparable across different platforms and/or across virtualized nodes (e.g., because the processing performance score provides comparable units of measure across different platforms and/or across virtualized nodes).

In some implementations, the processing capacity utilization score may be a function of the utilization score and the processing performance score of the current virtualized node. For example, the processing capacity utilization score may be the processing performance score multiplied by the utilization score, such as when the utilization score is in terms of a percentage of resource utilized. For example, if the processing performance score of the current virtualized node is 3,700 and the utilization score of the application is 60%, then the processing capacity utilization score may be 2,200.

The processing capacity utilization score may indicate a processing performance score threshold associated with supporting a deployment of the application. For example, the processing capacity utilization score may indicate a minimum processing performance score needed to support the deployment of the application. For example, the optimization device may determine, for the application, one or more performance thresholds based on the processing capacity utilization score and the one or more processing parameters of the application. The one or more performance thresholds may include the processing performance score threshold, a memory utilization threshold (e.g., a minimum amount of memory supported by a virtualized instance in units of bytes (or megabytes)), a NIC utilization threshold (e.g., in units of I/O), a disk utilization threshold (e.g., in units of IOPS), and/or other thresholds.

As shown in FIG. 1E, and by reference number 140, the optimization device may obtain, via the node configuration repository, virtualized node information for one or more virtualized nodes associated with the cloud computing environment. In some implementations, the virtualized node information may be for all virtualized nodes in the cloud computing environment. In other examples, the virtualized node information may be for virtualized nodes via which the application is deployable (e.g., based on a configuration of the application, a zone or geographic area associated with the application, and/or other attributes or parameters of the application). This may conserve processing resources and/or computing resources, among other examples, that would have otherwise been used by the optimization device to analyze virtualized nodes via which the application is not deployable.

As shown by reference number 145, the optimization device may determine one or more recommended virtualized nodes for the application. The optimization device may determine the one or more recommended virtualized nodes based on the processing capacity utilization score of the application and/or workload information of the application (e.g., the one or more performance thresholds). Additionally, the optimization device may determine the one or more recommended virtualized nodes based on the virtualized node information of the one or more recommended virtualized nodes (e.g., based on processing performance scores and/or other processing characteristics of the one or more recommended virtualized nodes).

For example, the optimization device may identify or determine one or more virtualized nodes that satisfy the one or more performance thresholds of the application. For example, the optimization device may determine, for each recommended virtualized node of the one or more recommended virtualized nodes, that values of respective processing characteristics of that recommended virtualized node satisfy the one or more performance thresholds of the application. As an example, the optimization device may determine that a processing performance score of a virtualized node satisfies a processing performance score threshold (e.g., that is based on, or that is, the processing capacity utilization score of the application). Additionally, the optimization device may determine that a processing performance score of a virtualized node satisfies a memory utilization threshold, a NIC utilization threshold, a disk utilization threshold, and/or another performance threshold of the application.

As an example and as shown in FIG. 1E, a Node 2, a Node 3, and a Node 4 may each have processing performance scores that satisfy the processing performance score threshold of the application. For example, the processing performance score threshold of the application may be 500 (e.g., based on the processing capacity utilization score of the application) and each of the Node 2, a Node 3, and a Node 4 may have processing performance scores that are greater than or equal to 500. However, the Node 4 may not be a recommended virtualized node because the Node 4 may not satisfy a disk utilization threshold of the application. For example, as shown in FIG. 1E, the workload information for the application may indicate a disk utilization threshold of 500 IOPS. However, the Node 4 may support a disk read/write (R/W) value of 250 IOPS. Therefore, the Node 4 may not support the disk utilization of the application. As a result, the optimization device may determine that the Node 4 is not a recommended virtualized node for the application. As shown in FIG. 1E, the Node 2 and the Node 3 may be associated with processing characteristics that satisfy the one or more performance thresholds of the application (e.g., the processing performance score threshold, the memory utilization threshold, the NIC utilization threshold, and/or the disk utilization threshold). Therefore, the optimization device may determine that the Node 2 and the Node 3 are recommended virtualized nodes for the application.

As shown by reference number 150, the optimization device may determine efficiency scores for respective recommended virtualized nodes of the one or more recommended virtualized nodes. The efficiency scores may be associated with a metric. For example, the metric may be a cost metric (e.g., indicating a cost of a given virtualized node as charged by a cloud service provider), a power metric (e.g., an energy consumption), a performance-per-cost metric (e.g., indicating performance achieved relative to cost incurred), and/or another metric. The one or more recommended virtualized nodes may be associated with respective values, of one or more values, of the metric. For example, as shown in FIG. 1E, the metric may be a cost metric and the Node 2 may have a value of $0.75, the Node 3 may have a value of $1.25, and the current virtualized node may have a value of $1.35. The efficiency scores may indicate ratios of the respective values to a lowest value or a highest value of the one or more values. For example, for a cost metric, the efficiency score may indicate a ratio of a given cost to a lowest cost of a virtualized instance that can support the deployment of the application. This may indicate the cost efficiency of the one or more recommended virtualized nodes and the current virtualized node relative to a lowest cost that can be incurred to support the deployment of the application. For example, a lowest cost of a virtualized node that can support the deployment of the application (e.g., that have processing characteristics that satisfy the one or more performance thresholds of the application) may be $0.70. As a result, the Node 2 may have an efficiency score of 93% (e.g., 0.70 divided by 0.75), the Node 3 may have an efficiency score of 56% (e.g., 0.70 divided by 1.25), and the current virtualized node may have an efficiency score of 52% (e.g., 0.70 divided by 1.35).

As shown in FIG. 1F, and by reference number 155, the optimization device may perform one or more actions for a selection of a virtualized node for the application. For example, as shown by reference number 160, the one or more actions may include providing, to a client device, recommendation information. For example, the optimization device may provide, for display via the client device, display information indicating virtualized nodes, from the current virtualized node and the one or more recommended virtualized nodes, and corresponding efficiency scores from the efficiency scores. As shown by reference number 165, the client device may display the recommendation information (e.g., the display information). For example, the client device may display processing characteristics of the currently virtualized node and processing characteristics of one or more recommended virtualized nodes in the same user interface and/or the same graphical element. This may enable reliable comparison of different virtualized nodes and a comparison of the efficiencies of the respective virtualized nodes. This may enable a reliable and/or accurate comparison of different virtualized nodes that can be used for a deployment of the application.

For example, in some cases, the client device may obtain a user input indicating that the application is to be deployed via a recommended virtualized node. The client device (and/or the optimization device) may cause the application to be deployed via the recommended virtualized node. For example, the recommended virtualized node selected by the user may be more efficient than the current virtualized node (e.g., in terms of the metric used to calculate the efficiency scores). As a result, the application may be deployed via a virtualized node that supports the application and that improves a resource utilization efficiency (e.g., a cost efficiency or another resource efficiency) of the deployment of the application. By enabling the selection of an optimized virtualized node for the application, a resource utilization efficiency of the cloud computing environment may be improved. The improvement of the resource utilization efficiency may improve the overall performance of the cloud computing environment, such as increasing processing speed and/or capacity of cloud computing resources associated with the cloud computing environment.

In some implementations, the one or more actions may include the optimization device causing the application to be deployed via a recommended virtualized node. For example, the optimization device may cause the application to be deployed via a virtualized node (e.g., from the current virtualized node and the one or more recommended virtualized nodes) that is associated with a best (e.g., a highest or lowest) efficiency score among the efficiency score of the current virtualized node and the one or more recommended virtualized nodes. In other words, the optimization device may cause the application to be deployed via a virtualized node that has processing characteristics that support the deployment of the application and that is most efficient in terms of a given metric, such as a cost metric or another metric. The virtualized node via which the application is deployed (e.g., based on the user input and/or the determination of the optimization device) may be referred to as an operating virtualized node of the application.

For example, by using processing performance scores that are determined as described herein, the optimization device may accurately and/or reliably compare the processing performance, processing capacity, and/or processing capabilities of virtualized nodes that are supported by different types of physical processors and/or processing systems. The accurate and/or reliable comparison of the processing performance, processing capacity, and/or processing capabilities enables the optimization device to improve the selection of a virtualized node via which the application is to be deployed. For example, by using the processing capacity utilization score (and one or more processing parameters of the application, such as memory utilization and/or disk utilization), the optimization device may improve the selection of the virtualized node via which the application is to be deployed using processing performance scores of respective virtualized instances and processing characteristics of the respective virtualized nodes.

As indicated above, FIGS. 1A-1F are provided as an example. Other examples may differ from what is described with regard to FIGS. 1A-1F.

FIG. 2 is a diagram of an example environment 200 in which systems and/or methods described herein may be implemented. As shown in FIG. 2, environment 200 may include a cloud computing environment 201, which may include one or more elements of and/or may execute within a cloud computing system 202. The cloud computing system 202 may include one or more elements 203-212, as described in more detail below. As further shown in FIG. 2, environment 200 may include a network 220, a optimization device 230, a node configuration repository 240, and/or a client device 250. Devices and/or elements of environment 200 may interconnect via wired connections and/or wireless connections.

The cloud computing system 202 may include computing hardware 203, a resource management component 204, a host operating system (OS) 205, and/or one or more virtual computing systems 206. The cloud computing system 202 may execute on, for example, an AMAZON WEB SERVICES platform, a MICROSOFT AZURE platform, or a SNOWFLAKE platform, among other examples. The resource management component 204 may perform virtualization (e.g., abstraction) of computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from computing hardware 203 of the single computing device. In this way, computing hardware 203 can operate more efficiently, with lower power consumption, higher reliability, higher availability, higher utilization, greater flexibility, and lower cost than using separate computing devices. The one or more virtual computing systems 206 may be referred to herein as virtualized nodes, nodes, virtualized instances, and/or instances, among other examples.

The computing hardware 203 may include hardware and corresponding resources from one or more computing devices. As described herein, a processing performance or processing capacity (e.g., a processing performance score) for a virtual computing system 206 may be based on, or otherwise associated with, characteristics or parameters of computing hardware 203 that support the virtual computing system 206. The computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using computing hardware 203. As shown, a virtual computing system 206 may include a virtual machine 210, a container 211, or a hybrid environment 212 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

Although the cloud computing environment 201 may include one or more elements 203-212 of the cloud computing system 202, may execute within the cloud computing system 202, and/or may be hosted within the cloud computing system 202, in some implementations, the cloud computing environment 201 may not be cloud-based (e.g., may be implemented outside of a cloud computing system) or may be partially cloud-based. For example, the cloud computing environment 201 may include one or more devices that are not part of the cloud computing system 202, such as device 300 of FIG. 3, which may include a standalone server or another type of computing device. The cloud computing environment 201 may perform one or more operations and/or processes described in more detail elsewhere herein.

The network 220 may include one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The optimization device 230 may include one or more devices capable of receiving, generating, storing, processing, providing, and/or routing information associated with optimizing virtualized node selection, as described elsewhere herein. The optimization device 230 may include a communication device and/or a computing device. For example, the optimization device 230 may include a server, such as an application server, a client server, a web server, a database server, a host server, a proxy server, a virtual server (e.g., executing on computing hardware), or a server in a cloud computing system. In some implementations, the optimization device 230 may include computing hardware used in a cloud computing environment, such as the cloud computing environment 201.

The node configuration repository 240 may include one or more devices capable of receiving, generating, storing, processing, and/or providing information associated with optimizing virtualized node selection, as described elsewhere herein. The node configuration repository 240 may include a communication device and/or a computing device. For example, the node configuration repository 240 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment (such as the cloud computing environment 201), or a similar type of device. As an example, the node configuration repository 240 may store information (e.g., processing performance scores and/or other processing characteristics) of one or more virtualized nodes or instances (such as one or more virtual computing systems 206), as described elsewhere herein.

The client device 250 may include one or more devices capable of receiving, generating, storing, processing, and/or providing information associated with optimizing virtualized node selection, as described elsewhere herein. The client device 250 may include a communication device and/or a computing device. For example, the client device 250 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300 associated with optimizing virtualized node selection. The device 300 may correspond to the cloud computing environment 201, a component associated with the cloud computing environment 201 (e.g., computing hardware 203), the optimization device 230, the node configuration repository 240, and/or the client device 250. In some implementations, the cloud computing environment 201, a component associated with the cloud computing environment 201 (e.g., computing hardware 203), the optimization device 230, the node configuration repository 240, and/or the client device 250 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

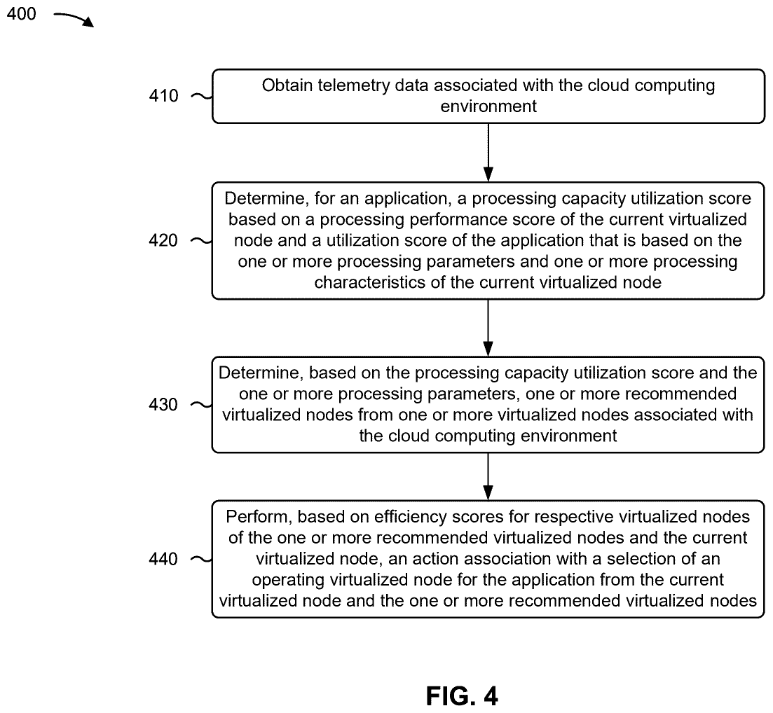

FIG. 4 is a flowchart of an example process 400 associated with optimizing virtualized node selection. In some implementations, one or more process blocks of FIG. 4 may be performed by the optimization device 230. In some implementations, one or more process blocks of FIG. 4 may be performed by another device or a group of devices separate from or including the optimization device 230, such as the cloud computing environment 201, the cloud computing system 202, a component of the cloud computing system 202, the node configuration repository 240, and/or the client device 250. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining telemetry data associated with the cloud computing environment (block 410). For example, the optimization device 230 (e.g., using processor 320 and/or memory 330) may obtain telemetry data associated with the cloud computing environment, as described above in connection with reference number 125 of FIG. 1D. As an example, the telemetry data indicates one or more processing parameters of an application deployed in the cloud computing environment via a current virtualized node.

As further shown in FIG. 4, process 400 may include determining, for the application, a processing capacity utilization score based on a processing performance score of the current virtualized node and a utilization score of the application that is based on the one or more processing parameters and one or more processing characteristics of the current virtualized node (block 420). For example, the optimization device 230 (e.g., using processor 320 and/or memory 330) may determine, for the application, a processing capacity utilization score based on a processing performance score of the current virtualized node and a utilization score of the application that is based on the one or more processing parameters and one or more processing characteristics of the current virtualized node, as described above in connection with reference number 135 of FIG. 1D. In some implementations, the processing performance score is based on a baseline processing performance score of an origin virtualized node and a relative ratio indicating a first processing performance of the current virtualized node relative to a second processing performance associated with the origin virtualized node.

As further shown in FIG. 4, process 400 may include determining, based on the processing capacity utilization score and the one or more processing parameters, one or more recommended virtualized nodes from one or more virtualized nodes associated with the cloud computing environment (block 430). For example, the optimization device 230 (e.g., using processor 320 and/or memory 330) may determine, based on the processing capacity utilization score and the one or more processing parameters, one or more recommended virtualized nodes from one or more virtualized nodes associated with the cloud computing environment, as described above in connection with reference number 145 of FIG. 1E. In some implementations, the one or more recommended virtualized nodes satisfy one or more processing performance criteria for the application indicated by the processing capacity utilization score and the one or more processing parameters.

As further shown in FIG. 4, process 400 may include performing, based on efficiency scores for respective virtualized nodes of the one or more recommended virtualized nodes and the current virtualized node, an action associated with a selection of an operating virtualized node for the application from the current virtualized node and the one or more recommended virtualized nodes (block 440). For example, the optimization device 230 (e.g., using processor 320 and/or memory 330) may perform, based on efficiency scores for respective virtualized nodes of the one or more recommended virtualized nodes and the current virtualized node, an action associated with a selection of an operating virtualized node for the application from the current virtualized node and the one or more recommended virtualized nodes, as described above in connection with reference number 155 of FIG. 1F. As an example, the optimization device 230 may cause recommendation information (e.g., indicating the one or more recommended virtualized nodes and/or the efficiency scores) to be displayed, such as by the client device 250. Additionally, or alternatively, the optimization device 230 may cause the application to be deployed via a virtualized node that is selected (e.g., by the optimization device 230 or another device) from the current virtualized node and the one or more recommended virtualized nodes based on the efficiency scores.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1F. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for optimizing virtualized node selection in a cloud computing environment, the system comprising:
one or more memories; and
one or more processors, communicatively coupled to the one or more memories, configured to:
determine a baseline processing performance score using an origin virtualized node deployed in the cloud computing environment, wherein the baseline processing performance score is based on a processing performance of a physical processing system supporting the origin virtualized node;
determine relative ratios for respective virtualized nodes of one or more virtualized nodes deployed in the cloud computing environment, wherein the relative ratios indicate relative processing performances that are relative to the processing performance;
determine processing performance scores for the respective virtualized nodes based on the relative ratios and the baseline processing performance score;
determine, for an application deployed in the cloud computing environment via a virtualized node of the one or more virtualized nodes, a processing capacity utilization score based on a processing performance score of the virtualized node and a utilization score of the application that is based on telemetry data associated with the application and one or more processing characteristics of the virtualized node;
determine, based on the processing capacity utilization score and one or more processing parameters of the application, one or more recommended virtualized nodes from the one or more virtualized nodes; and
perform, based on efficiency scores for respective virtualized nodes of the one or more recommended virtualized nodes and the virtualized node, an action associated with a selection of an operating virtualized node for the application from the virtualized node and the one or more recommended virtualized nodes.

2. The system of claim 1, wherein the one or more processing parameters of the physical processing system supporting the origin virtualized node include at least one of:
a clock speed,
a quantity of cores,
a cache size, or
an instruction set architecture.

3. The system of claim 1, wherein the relative ratios are based on respective processing characteristics of physical processing systems supporting the one or more virtualized nodes.

4. The system of claim 1, wherein the one or more processing parameters include at least one of:
a memory utilization metric, or
a disk utilization metric.

5. The system of claim 1, wherein the one or more processors are further configured to:
determine, for the application, one or more performance thresholds based on the processing capacity utilization score and the one or more processing parameters of the application.

6. The system of claim 5, wherein the one or more processors, to determine the one or more recommended virtualized nodes, are configured to:
determine, for each recommended virtualized node of the one or more recommended virtualized nodes, that values of respective processing characteristics of that recommended virtualized node satisfy the one or more performance thresholds.

7. The system of claim 1, wherein the processing capacity utilization score indicates a processing performance score threshold associated with supporting a deployment of the application.

8. The system of claim 1, wherein the one or more recommended virtualized nodes are associated with respective values, of one or more values, of a metric, and
wherein the efficiency scores indicate ratios of the respective values to a lowest value or a highest value of the one or more values.

9. The system of claim 8, wherein the metric is a cost metric.

10. The system of claim 1, wherein the one or more processors, to perform the action, are configured to:
determine, based on the efficiency scores, the operating virtualized node from the virtualized node and the one or more recommended virtualized nodes; and
cause the application to be deployed via the operating virtualized node.

11. A method for optimizing virtualized node selection in a cloud computing environment comprising:
obtaining, by a device, telemetry data associated with the cloud computing environment, wherein the telemetry data indicates one or more processing parameters of an application deployed in the cloud computing environment via a current virtualized node;
determining, by the device and for the application, a processing capacity utilization score based on a processing performance score of the current virtualized node and a utilization score of the application that is based on the one or more processing parameters and one or more processing characteristics of the current virtualized node,
wherein the processing performance score is based on a baseline processing performance score of an origin virtualized node and a relative ratio indicating a first processing performance of the current virtualized node relative to a second processing performance associated with the origin virtualized node;
determining, by the device and based on the processing capacity utilization score and the one or more processing parameters, one or more recommended virtualized nodes from one or more virtualized nodes associated with the cloud computing environment,
wherein the one or more recommended virtualized nodes satisfy one or more processing performance criteria for the application indicated by the processing capacity utilization score and the one or more processing parameters; and
performing, by the device and based on efficiency scores for respective virtualized nodes of the one or more recommended virtualized nodes and the current virtualized node, an action associated with a selection of an operating virtualized node for the application from the current virtualized node and the one or more recommended virtualized nodes.

12. The method of claim 11, wherein the telemetry data includes at least one of:
a resource quantity,
a resource performance setting,
a quantity of communicated packets,
a first size of communicated data,
a quantity of read or write requests,
a second size of the read or write requests, or
one or more library architecture parameters.

13. The method of claim 11, wherein the baseline processing performance score is based on one or more characteristics of a processing system configured to support the origin virtualized node, wherein the one or more characteristics include at least one of:
a clock speed,
a quantity of cores,
a cache size, or
an instruction set architecture.

14. The method of claim 11, wherein the one or more processing parameters include at least one of:
a memory utilization metric, or
a disk utilization metric.

15. The method of claim 11, wherein the processing capacity utilization score indicates a processing performance score threshold associated with supporting a deployment of the application, and wherein the processing performance score threshold is included in the one or more processing performance criteria.

16. The method of claim 11, wherein the one or more recommended virtualized nodes are associated with respective values, of one or more values, of a metric, and
wherein the efficiency scores indicate ratios of the respective values to a lowest value or a highest value of the one or more values.

17. The method of claim 11, wherein performing the action comprises:
providing, for display, display information indicating virtualized nodes, from the current virtualized node and the one or more recommended virtualized nodes, and corresponding efficiency scores from the efficiency scores.

18. A non-transitory computer-readable medium storing a set of instructions, the set of instructions comprising:
one or more instructions that, when executed by one or more processors of a device, cause the device to:
obtain telemetry data associated with a cloud computing environment, wherein the telemetry data indicates one or more processing parameters of an application deployed in the cloud computing environment via a current virtualized node;
determine, for the application, a processing capacity utilization score based on a processing performance score of the current virtualized node and a utilization score of the application that is based on the one or more processing parameters and one or more processing characteristics of the current virtualized node,
wherein the processing performance score is based on a baseline processing performance score of an origin virtualized node and a relative ratio indicating a first processing performance of the current virtualized node relative to a second processing performance associated with the origin virtualized node;
determine, based on the processing capacity utilization score and the one or more processing parameters, one or more recommended virtualized nodes from one or more virtualized nodes associated with the cloud computing environment,
wherein the one or more recommended virtualized nodes meet one or more processing performance criteria for the application indicated by the processing capacity utilization score and the one or more processing parameters; and
perform, based on efficiency scores for respective virtualized nodes of the one or more recommended virtualized nodes and the current virtualized node, an action associated with a selection of an operating virtualized node for the application from the current virtualized node and the one or more recommended virtualized nodes.

19. The non-transitory computer-readable medium of claim 18, wherein the baseline processing performance score is based on one or more characteristics of a processing system configured to support the origin virtualized node, wherein the one or more characteristics include:
a clock speed,
a quantity of cores, and
a cache size.

20. The non-transitory computer-readable medium of claim 18, wherein the one or more instructions, that cause the device to perform the action, cause the device to:
determine, based on the efficiency scores, the operating virtualized node from the current virtualized node and the one or more recommended virtualized nodes; and
cause the application to be deployed via the operating virtualized node.
